(19) United States
(12) Patent Application Publication
(10) Pub. No.: US 2009/0261077 A1
(43) Pub. Date: Oct. 22, 2009

(54) HEAT TREATMENT HOLDER AND HEAT TREATMENT APPARATUS AND METHOD

(76) Inventor: Kazuhiko Katsumata, Saitama-shi (JP)

Correspondence Address: OSTROLENK FABER GERB & SOFFEN, 1180 AVENUE OF THE AMERICAS, NEW YORK, NY, 100368403, US

(21) Appl. No.: 12/064,904

(22) PCT Filed: Aug. 31, 2005
(86) PCT No.: PCT/JP2005/015904

§ 371 Date: Feb. 26, 2008

(51) Int. Cl. C21D 1/40; H05B 3/12; F27D 11/02

(52) U.S. Cl. 219/117.1; 219/78.01

(57) ABSTRACT

The object of the present invention is suppression of a cost increase of a heat treatment holder as well as achievement of equalization of heater output and improvement of thermal efficiency by broadening the selection scope of materials of the heat treatment holder (particularly, materials of the resistance heating element). In the present invention, in the case of performing heat treatment on an object to be treated, as a heat treatment holder that holds the object to be treated and heats the object to be treated by undergoing resistance heating by carrying electric current from an external source, one is used that is formed by a resistance heating material having a specific resistance higher than a base material of the resistance heating element being mixed in the base material.

### TECHNICAL FIELD

The present invention relates to a heat treatment holder that holds an object to be treated and a heat treatment apparatus and method that heat treats the object to be treated that is held by the heat treatment holder.

### BACKGROUND ART

For example, Japanese Unexamined Patent Application, First Publication No. 2004-315917 discloses an invention that performs heat treatment on an object to be treated by heating with a plurality of heaters an object to be treated that is held by a heat treatment holder and causing the heat treatment holder to generate resistance heat by the passage of electric current.

In the case of attempting to uniformly heat an object to be treated that is held by a heat treatment holder using heaters plurally provided in a heat treatment furnace, problems arise of not being able to equalize the output of each heater due to the heat capacity of the heat treatment holder and the hearth that is positioned under the heat treatment holder and, due to this, the thermal efficiency falling due to an increase in the heat discharge from the vicinity of the high output heaters in the heat treatment furnace to the outside. This invention solves these issues by supplementary heating of the object to be heat treated by causing the heat treatment holder (precisely, the resistance heating element) to undergo resistance heating by passing electric current in addition to heating of the object to be treated by the heaters, whereby it is possible to equalize the output of the plurality of heaters and also raise the thermal efficiency.

Note that in Japanese Unexamined Patent Application, First Publication No. 2004-315917, references are made to inventions disclosed in Japanese Unexamined Patent Application, First Publication No. H11-171655 and Japanese Unexamined Patent Application, First Publication No. 2000-73106, and these inventions are pointed out as unable to solve the above technical issues.

Patent Document 1: Japanese Unexamined Patent Application No. 2004-315917

Patent Document 2: Japanese Unexamined Patent Application No. H1-171655

Patent Document 3: Japanese Unexamined Patent Application No. 2000-73106

### DISCLOSURE OF INVENTION

### Problem to be Solved by the Invention

The above previous inventions are preceding inventions by the present applicants, and the materials of the resistance heating elements in the heat treatment holder are limited to materials with a high heat resistance and with a comparatively high specific resistance. In Japanese Unexamined Patent Application, First Publication No. 2004-315917, graphite, Nichrome, tungsten, molybdenum, tantalum, ceramics, and Fe—Cr—Al are given as materials for a resistance heating element having such properties.

However, compared to heat resisting steel conventionally used as the heat treatment holder, these resistance heating element materials are costly as materials and have inferior workability. Accordingly, the above conventional inventions have the problem of the heat treatment holder being more costly than conventional heat treatment holders. The development of technology that enables equalization of heater output and improvement of thermal efficiency without raising the cost of the heat treatment holder has therefore been desired.

The present invention was achieved in view of the aforementioned circumstances, and has as its object suppression of a cost increase of the heat treatment holder as well as achievement of equalization of heater output and improvement of thermal efficiency by broadening the selection scope of materials of the heat treatment holder (particularly, materials of the resistance heating elements).

### Means for Solving the Problem

The present invention adopts the solving means of using a heat treatment holder in which a resistance heating material having specific resistance higher than a base material of the resistance heating elements is mixed in the base material.

In accordance with the present invention, by mixing the resistance heating material in the base material of the resistance heating elements, it is possible to make the specific resistance of the heat treatment holder higher than the original specific resistance of the base material. Accordingly, since selection of materials with a comparatively low specific resistance as the base material of the resistance heating elements becomes possible, it becomes possible to broaden the selection range of base materials of the resistance heating elements, and as a result a cost reduction and improvement in workability of the heat treatment holder become possible.

In accordance with the present invention, since it is possible to adopt, for example, heat resisting steel that has been conventionally used as the heat treatment holder, it is possible to reliably achieve a cost reduction and improvement in workability in the heat treatment holder.

Also, the present invention adopts the solution means of using a heat treatment holder in which a resistance heating material having a specific resistance higher than the base material is formed as a coating on the surface of the base material of the resistance heating elements.

In accordance with this invention, since the resistance heating material is formed as a coating on the surface of the base material of the resistance heating elements, it is possible to make the specific resistance higher than the base material at the surface of the heat treatment holder, and thereby it becomes possible to select a material with a specific resistance that is comparatively low as the base material of the resistance heating elements.

Also, the present invention adopts the solution means of using a heat treatment holder in which a plurality of element members of a predetermined shape are connected.

In accordance with this invention, resistance heating occurs by contact resistance at the connecting portions of the element members. Accordingly, since it is possible to select materials with a comparatively low specific resistance as the base material of the resistance heating elements, it becomes possible to broaden the selection range of base materials of the resistance heating elements.

### BRIEF DESCRIPTION OF THE DRAWINGS

FIG. 1 is a longitudinal sectional view taken in the direction of the arrows that shows the constitution of the heat treatment apparatus in accordance with an embodiment of the present invention.

FIG. 2A is an enlarged front view that shows the constitution of the tray-shaped heat treatment holder in accordance with an embodiment of the present invention.

FIG. 2B is an enlarged side view that shows the constitution of the tray-shaped heat treatment holder in accordance with an embodiment of the present invention.

FIG. 3A is a perspective view that shows the constitution of a resistance heating element in the first embodiment of the present invention.

FIG. 3B is a schematic view that shows an enlarged sectional view of the resistance heating element in the first embodiment of the present invention.

FIG. 4 is a perspective view that shows the constitution of a basket-shaped heat treatment holder in accordance with an embodiment of the present invention.

FIG. 5A is a perspective view that shows the constitution of the resistance heating element in the second embodiment of the present invention.

FIG. 5B is a schematic view that shows an enlarged sectional view of the resistance heating element in the second embodiment of the present invention.

FIG. 6A is a perspective view that shows the constitution of the resistance heating element in the third embodiment of the present invention.

FIG. 6B is a schematic view that shows an enlarged sectional view of the resistance heating element in the third embodiment of the present invention.

FIG. 7A is a perspective view that shows the constitution of the resistance heating element in the fourth embodiment of the present invention.

FIG. 7B is a schematic view that shows an enlarged sectional view of the resistance heating element in the fourth embodiment of the present invention.

### BRIEF DESCRIPTION OF THE REFERENCE SYMBOLS

X object to be treated
Y heat treatment holder
Y1 tray-shaped heat treatment holder
Y2 basket-shaped heat treatment holder
y1, y2, y9, y10 side plates
y3, y11, y15, y16, y17, y18 connecting plates
y4, y12 reinforcing plates
y5 base material
y6 resistance heating material
y7 bottom portion
y8 circumferential side portion
y13, y14 frames
y18 carbon implantation region
1 main body container
2 heat chamber
3A, 3B power feeding portions
4 hearth
5A to 5B heaters
6A, 6B contact electrodes
7A, 7B connection electrodes
8A, 8B bar-shaped support members
9A, 9B cylinders
10A, 10B through-electrodes
11A, 11B wires

### BEST MODE FOR CARRYING OUT THE INVENTION

The preferred embodiments of the present invention shall be described hereinbelow with reference to the drawings.

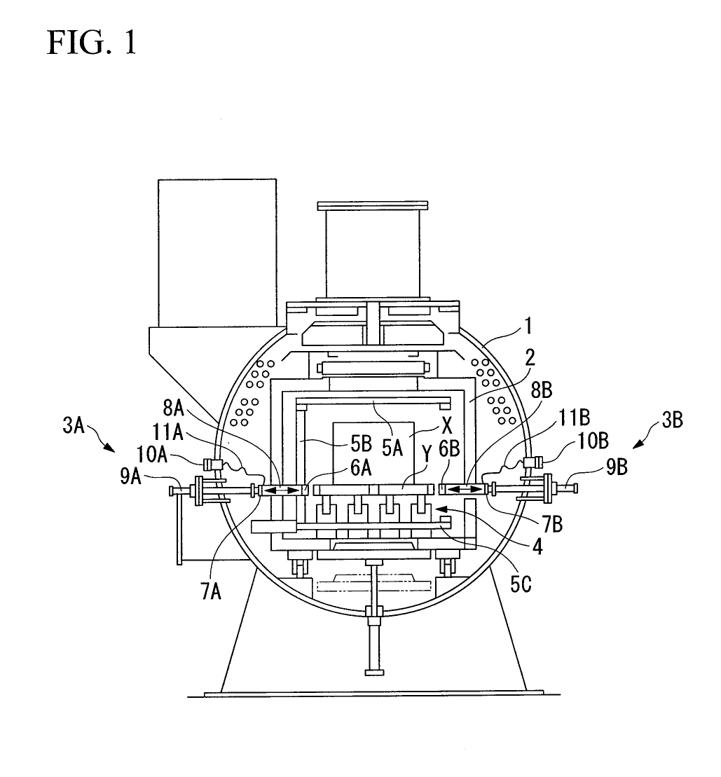

Note that the first to fourth embodiments are ones that have a particular constitution for the heat treatment holder that holds the object to be treated within a heat treatment apparatus, and the constitution of the heat treatment apparatus is approximately the same for all. Accordingly, prior to describing the first to fourth embodiments, the overall constitution of the heat treatment apparatus shall be described with reference to FIG. 1.

A main body container 1 of the heat treatment apparatus is formed in an approximately hollow cylindrical shape, and installed on a floor in a lateral orientation. A door (not illustrated) for taking out and putting in an object to be treated X, which is held by a heat treatment holder Y (tray-shaped heat treatment holder), is provided at one end of such a main body container 1. Also, a heat chamber 2 that contains the heat treatment holder Y is provided in the main body container 1, while a pair of power feeding portions 3A, 3B is provided at both lateral portions of the main body container 1.

The heat chamber 2 is a container that is formed in a box shape by adiabatic walls, and in that inner portion a hearth 4 that supports the heat treatment holder Y is provided on the bottom portion, and heaters 5A to 5B for heating the object to be treated X are provided on the bottom portion, left side portion, and top portion.

The power feeding portions 3A, 3B are constituted from bar-shaped support members 8A, 8B in which contact electrodes 6A, 6B are provided at the distal end, and connection electrodes 7A, 7B that make contact with the contact electrodes 6A, 6B are provided at the inner portion and back end; cylinders 9A, 9B that move forward/backward the bar-shaped support members 8A, 8B; through-electrodes 10A, 10B that are connected to an external power supply (not illustrated) and provided in an airtight state and through state in the main body container 1; and wires 11A, 11B that respectively connect the through-electrodes 10A, 10B to the connection electrodes 7A, 7B and the like.

The above bar-shaped support members 8A, 8B are provided so as to pass through the heat chamber 2 as illustrated. By causing the bar-shaped support members 8A, 8B to move forward/backward by the cylinders 9A, 9B, the power feeding portions 3A, 3B cause the contact electrodes 6A, 6B to make contact with/separate from the heat treatment holder Y that is positioned at a specified position on the hearth 4.

Note that the present heat treating apparatus is a single-chamber type heat treatment furnace that performs batch-type heat treatment on objects to be treated X in a vacuum or inert gas environment, and is similar to that disclosed in Japanese Unexamined Patent Application, First Publication No. 2004-315917. This type of single-chamber type heat treatment furnace performs heat treatment such as hardening, tempering, annealing or normalizing or the like of steel and heat treatment for sintering or baking of ceramics, magnetic materials, carbon materials, or composite materials. Since a single-chamber type heat treatment furnace is described in detail in Japanese Unexamined Patent Application, First Publication No. 2004-315917, no additional details shall be provided in the present specification.

### A: First Embodiment

Next, a first embodiment of the present invention shall be described.

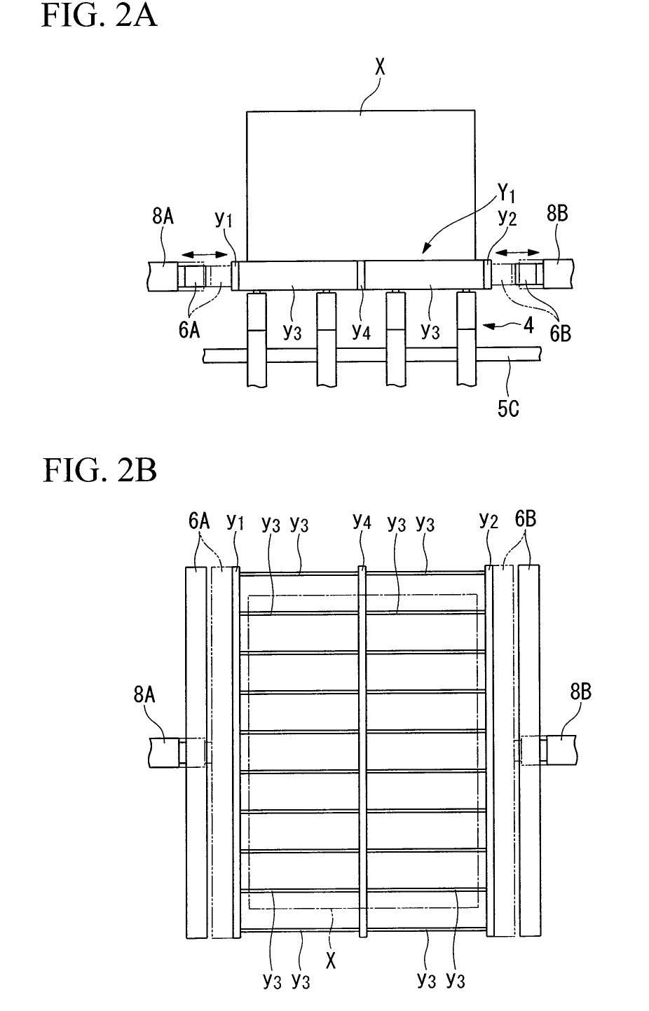

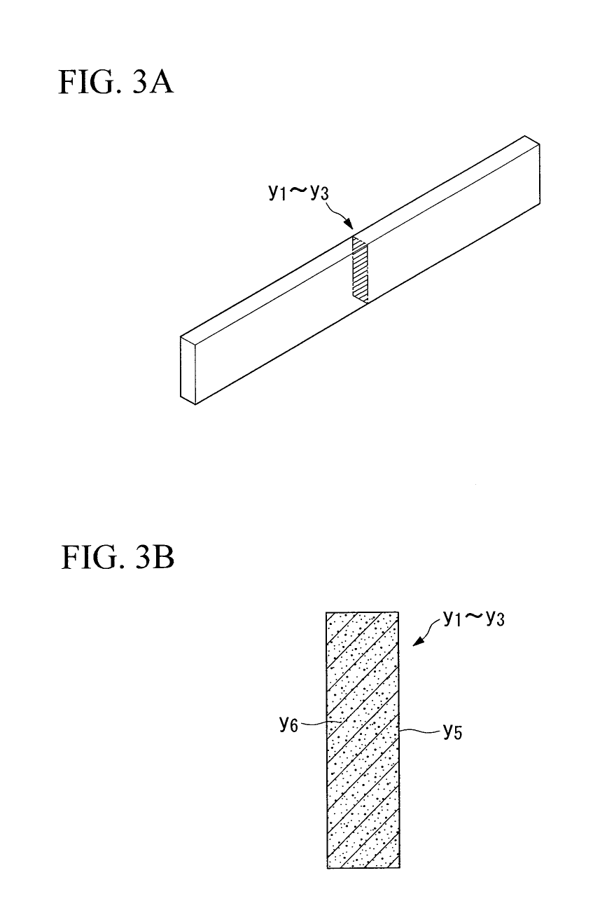

FIG. 2A and FIG. 2B show the constitution of the tray-shaped heat treatment holder Y1 in accordance with the first embodiment, and this tray-shaped heat treatment holder Y1 is constituted from a pair of side plates y1, y2 that are arranged in parallel, connecting plates y3 plurally provided at a predetermined spacing so as to extend between the side plates y1, y2, and a reinforcing plate y4 that is provided at the middle sections of the connecting plates y3 and of the same shape as and parallel to the side plates y1, y2.

The side plates y1, y2 and the connecting plates y3 are rectangular members that are formed from a material prepared by mixing a resistance heating material y6 having a specific resistance higher than a base material y5 having conductivity such as heat resisting steel with the base material y5 and offering resistance heating. Also, the reinforcing plate y4 is a member that is formed from a conductive member such as heat resisting steel, and mechanically reinforces the connecting plates y3 while electrically connects the middle sections of the connecting plates y3.

That is, the tray-shaped heat treatment holder Y1 is one in which between the side plates y1, y2, which are resistance heating elements, a plurality of connecting plates y3 which are also resistance heating elements are provided in parallel. Such a tray-shaped heat treatment holder Y1 is therefore one in which the plurality of resistance heating elements (connecting plates y3) are connected in parallel between resistance heating elements (side plates y1, y2) from electric circuit point of view.

Since the present heat treatment apparatus is required to have the ability to carry out heat treatment on an object to be treated X at a treatment temperature of, for example, 850° C., the component materials of the tray-shaped heat treatment holder Y1 are required to have sufficient stability at the above-mentioned treatment temperature. The base material y5 in the above resistance heating elements (that is, the side plates y1, y2 and the connecting plates y3) is one that, in addition to such a temperature requirement, is low cost due to a low material price and excellent workability, and has conductivity, with for example heat resisting steel being chosen.

Also, the resistance heating material y6 is one that consists of any one or a plurality of, for example, Manganin, non-nickel Manganin, Advance, Cu—Mn—Ge alloy, NBW108, Ni—Cr—Fe alloy, silicon carbide, Nichrome, and graphite. Among these materials, Manganin, non-nickel Manganin, Advance, Cu—Mn—Ge alloy, and NBW108 are metallic resistance materials.

Manganin is a material that consists of 85.65 weight % copper (Cu), 12 weight % manganese (Mn), 2 weight % nickel (Ni), 0.25 weight % iron (Fe), 0.1 weight % silicon (Si), and has a specific resistance of 49 μΩ·cm at room temperature (20° C.). Non-nickel Manganin is a material that consists of 85 weight % copper (Cu), 9.5 weight % manganese (Mn), and 5.5 weight % aluminum (Al), and has a specific resistance of 45 μΩ·cm at room temperature (20° C.).

Advance is a material that consists of 54.50 weight % copper (Cu), 0.54 weight % manganese (Mn), 44.65 weight % nickel (Ni), and 0.11 weight % iron (Fe), and has a specific resistance of 47.56 μΩ·cm at room temperature (20° C.). Cu—Mn—Ge alloy is a material that consists of 87.4 weight % copper (Cu), 2 weight % manganese (Mn), and 0.6 weight % germanium (Ge), and has a specific resistance of 35 μΩ·cm at room temperature (20° C.). NBW108 is a material that consists of 10 weight % manganese (Mn) and 82 to 88 weight % tin (Sn), and has a specific resistance of 55 μΩ·cm at room temperature (20° C.).

Ni—Cr—Fe alloy is a material that mainly consists of 60 weight % nickel (Ni), 12 weight % chrome (Cr), and 26 weight % iron (Fe), or 65 weight % nickel (Ni), 22 weight % chrome (Cr), 10 weight % iron (Fe), and 2 weight % manganese (Mn), and has a specific resistance of 17 μΩ·cm. Also, the Nichrome used in a Nichrome heater is a material that has a specific resistance of 110 μΩ·cm.

Silicon carbide is a material that mainly consists of 26 weight % carbon (C) and 63 weight % silicon (Si) with a specific resistance of 40 to 60 μΩ·cm. Also, graphite is a material that has a specific resistance of 1,000 to 1,500 μΩ·cm.

Note that the side plates y1, y2 and the connecting plates y3 (resistance heating elements) are formed from material prepared by blending a resistance heating material y6 with the above base material y5. The mode of this blending may be any one in which the base material y5 and the resistance heating material y6 are alloyed, or one in which the resistance heating material y6 in a particle state is dispersed in the base material y5.

The tray-shaped heat treatment holder Y1 is formed in a tray shape with the height dimension substantially short with respect to the length and width dimensions, as illustrated. The tray-shaped heat treatment holder Y1 in which the object to be treated X is placed on the top surface is mounted on the hearth 4 in the orientation of the side plates y1, y2 parallel to the aforementioned contact electrodes 6A, 6B.

In the case of holding the object to be treated X in the heat treatment apparatus of FIG. 1 using such a tray-shaped heat treatment holder Y1 and performing heat treatment, the heat treatment apparatus initially causes the contact electrodes 6A, 6B of the power feeding portions 3A, 3B to advance with respect to the heat treatment holder Y and make contact with the side plates y1, y2 of the heat treatment holder Y. Then, the heat treatment apparatus supplies power from the external power supply to the heaters 5A to 5B and the power feeding portions 3A, 3B and causes resistance heating in the heaters 5A to 5B and the resistance heating elements (the side plates y1, y2 and the connecting plates y3) of the tray-shaped heat treatment holder Y1. As a result, the object to be treated X is heated by heat that is emitted from the heaters 5A to 5B and the tray-shaped heat treatment holder Y1.

In accordance with this first embodiment, it is possible to correct non-uniformities in the output of the heaters 5A to 5B stemming from the thermal capacity of the tray-shaped heat treatment holder Y1 and the hearth 4 by the heating of the resistance heating elements (the side plates y1, y2 and the connecting plates y3). Therefore, it is possible to correct reductions in the thermal efficiency caused by non-uniformities in the output of the heaters 5A to 5B. Note that in the first embodiment, the side plates y1, y2 and the connecting plates y3 are resistance heating elements, but it is also acceptable for only the connecting plates y3 to be resistance heating elements and the side plates y1, y2 to be a conductive material such as heat resisting steel.

Also, in addition to such actions and effects, since the first embodiment uses the connecting plates y3 that consist of a material prepared by blending a resistance heating material y6 having a specific resistance higher than the base material y5 having conductivity such as heat resisting steel with the base material y5, while conventional resistance heating plates have been formed with only resistance materials such as graphite, Nichrome, tungsten, molybdenum, tantalum, ceramics, and Fe—Cr—Al and the like. Accordingly, it is possible to make the selection scope of materials of the connecting plates y3 (particularly the base material y5) broader than previously, and as a result enable a cost reduction and improvement in workability of the tray-shaped heat treatment holder Y1.

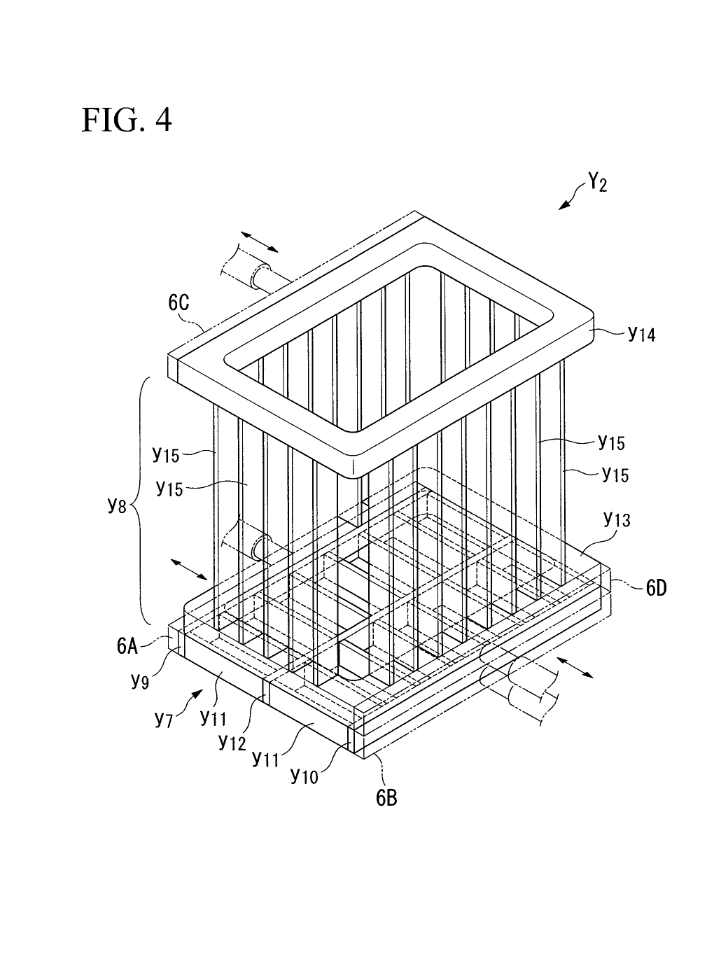

Note that the abovementioned connecting plates y3 can also be applied to a basket-shaped heat treatment holder Y2 as shown in FIG. 4 in addition to the tray-shaped heat treatment holder Y1 shown in FIG. 2.

The basket-shaped heat treatment holder Y2 is constituted from a bottom portion y7 having the same structure as the abovementioned tray-shaped heat treatment holder Y1 and a circumferential side portion y8 that is provided as a side wall on the bottom portion y7. The bottom portion y7 is constituted from a pair of side plates y9, y10 that are arranged in parallel, connecting plates y11 plurally provided at a predetermined spacing so as to extend between the side plates y9, y10, and a reinforcing plate y12 that is provided at the middle sections of the connecting plates y11 and of the same shape as and parallel to the side plates y9, y10. The side plates y9, y10 and the connecting plates y11 in this bottom portion y7 are resistance heating elements of the same material as the resistance heating elements of the aforementioned tray-shaped heat treatment holder Y1 (the side plates y1, y2 and the connecting plates y3).

The circumferential side portion y8 consists of a pair of frames y13, y14 that are oppositely disposed in the vertical direction and connecting plates y15 plurally provided at a predetermined spacing so as to extend between the side plates y13, y14. The frames y13, y14 and the connecting plates y15 in such a circumferential side portion y8 are resistance heating elements of the same material as the resistance heating elements of the aforementioned tray-shaped heat treatment holder Y1 (the side plates y1, y2 and the connecting plates y3).

The basket-shaped heat treatment holder Y2 constituted in this way holds the object to be treated X by housing a plurality of them, which are comparatively smaller, in the space that is surrounded by the bottom portion y7 and the circumferential side portion y8. Also, in the case of performing heat treatment on the object to be treated X using the basket-shaped heat treatment holder Y2, the contact electrodes 6A, 6B of the power feeding portions 3A, 3B advance with respect to the bottom portion y7 and make contact with the side plates y9, y10, and second contact electrodes 6C, 6D that are additionally mounted in the power feeding portions 3A, 3B as illustrated advance to make contact with the frames y13, y14.

In the basket-shaped heat treatment holder Y2 like this, when power is supplied to the power feeding portions 3A, 3B, since each of the resistance heating elements, that is, the side plates y9, y10 and connecting plates y11 of the bottom portion y7 and the frames y13, y14 and the connecting plates y15 of the circumferential side portion y8, generate resistance heat, it is possible to exhibit the same action/effect as the abovementioned tray-shaped heat treatment holder Y1.

Note that it is acceptable for only the connecting plates y11 of the bottom portion y7 and the connecting plates y15 of the circumferential side portion y8 to be resistance heating elements, and the side plates y9, y10 of the bottom portion y7 and the frames y13, y14 of the circumferential side portion y8 to be a conductive material such as heat resisting steel.

### B: Second Embodiment

Next, a second embodiment of the present invention shall be described.

Note that the second embodiment differs from the abovementioned first embodiment only in terms of the constitution of the resistance heating elements. Accordingly, in the following description, the constitution of the resistance heating elements (connecting plates y16) in the second embodiment shall be described. Also, in the following description, portions similar to those in the above-described first embodiment shall be given the same reference numerals and overlapping explanations thereof shall be omitted here.

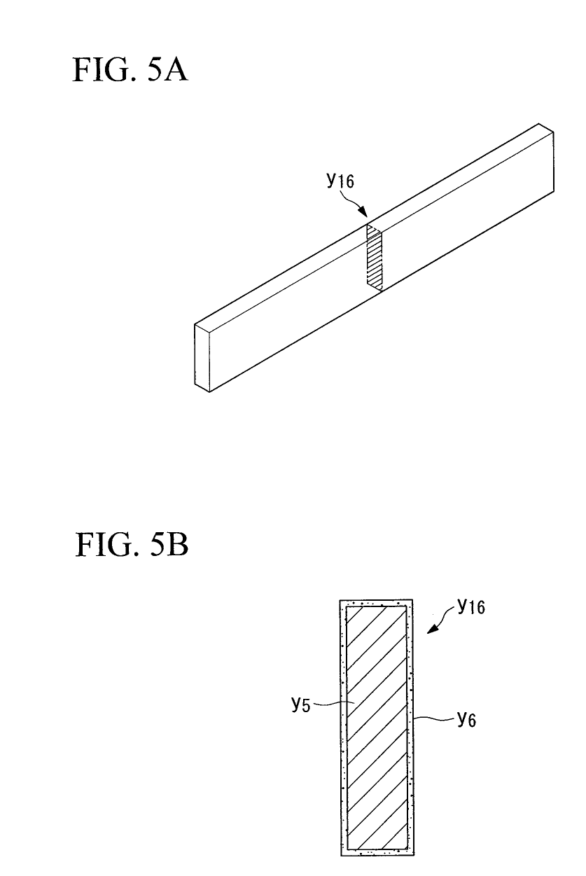

As shown in FIG. 5A and FIG. 5B, the connecting plate y16 is one in which the resistance heating material y6 is formed as a coating on the surface of the base material y5 that is formed in the shape of a plate. Methods of forming this coating include a method that involves coating a solvent that includes powder of the resistance heating material y6 on the surface of the base material y5 using a brush or spray or the like and then volatilizing the solvent with a drying treatment. The aforementioned solvent is, for example, a solvent such as alcohol.

Since this second embodiment uses the connecting plates y16 in which a coating of the resistance heating material y6 with a specific resistance higher than the base material y5 having conductivity such as heat resisting steel is formed on the surface of the base material y5, it is possible to broaden the selection scope of materials of the connecting plates y16 (particularly the base material y5). As a result, it enable a cost reduction and improvement in workability of the heat treatment holder (tray-shaped heat treatment holder and basket-shaped heat treatment holder), similarly to the above-described first embodiment.

### C: Third Embodiment

Next, a third embodiment of the present invention shall be described.

Note that the third embodiment, similarly to the above-described second embodiment, differs from the first embodiment only in terms of the constitution of the resistance heating elements. Accordingly, in the following description, the constitution of the resistance heating elements (connecting plates y17) in the third embodiment shall be described. Also, in the following description, portions similar to those in the above-described first embodiment shall be given the same reference numerals and overlapping explanations thereof shall be omitted here.

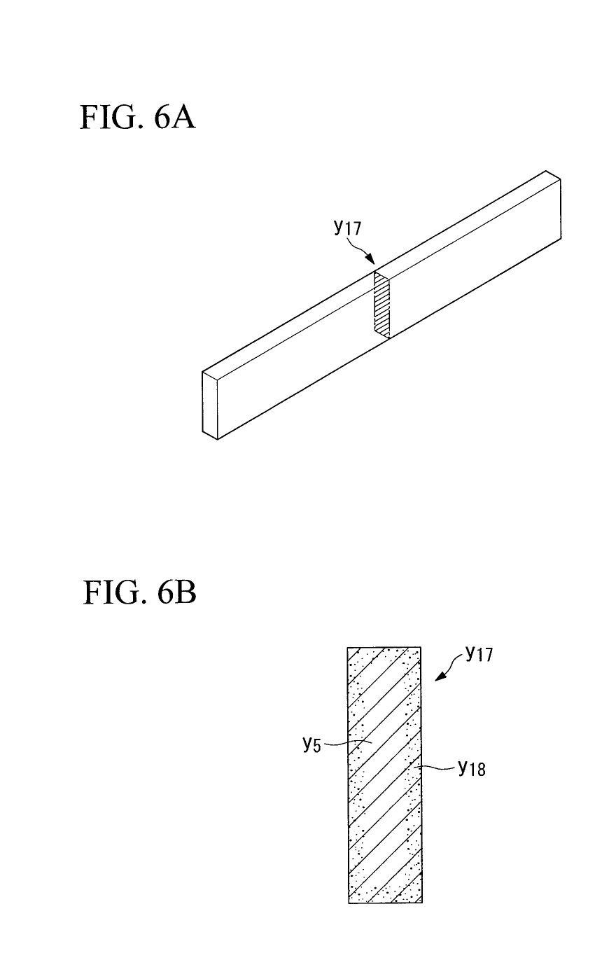

FIG. 6A and FIG. 6B show the connecting plate y17, in which a carburizing treatment is performed on the base material y5 that is formed in the shape of a plate to form a carbon implantation region y18 on the surface vicinity region of the base material y5. This carbon implantation region y18 is a region in which the specific resistance is greater than the specific resistance of the base material y5 as a result of carbon (C) being implanted by the carburizing treatment, and so generates resistance heat by passing electric current therethrough.

Since this third embodiment uses the connecting plates y17 in which the carbon implantation region y18 exists on the surface vicinity region of the base material y5, it is possible to broaden the selection scope of materials of the connecting plates y17 (particularly the base material y5), and as a result enable a cost reduction and improvement in workability of the heat treatment holder (tray-shaped heat treatment holder and basket-shaped heat treatment holder), similarly to the above-described first and second embodiments.

### D: Fourth Embodiment

Next, a fourth embodiment of the present invention shall be described.

The fourth embodiment, similarly to the above-described second and third embodiments, differs from the first embodiment only in terms of the constitution of the resistance heating elements. Accordingly, in the following description, the constitution of the resistance heating elements (connecting plates y17) in the fourth embodiment shall be described. Also, in the following description, portions similar to those in the above-described first embodiment shall be given the same reference numerals and overlapping explanations thereof shall be omitted here.

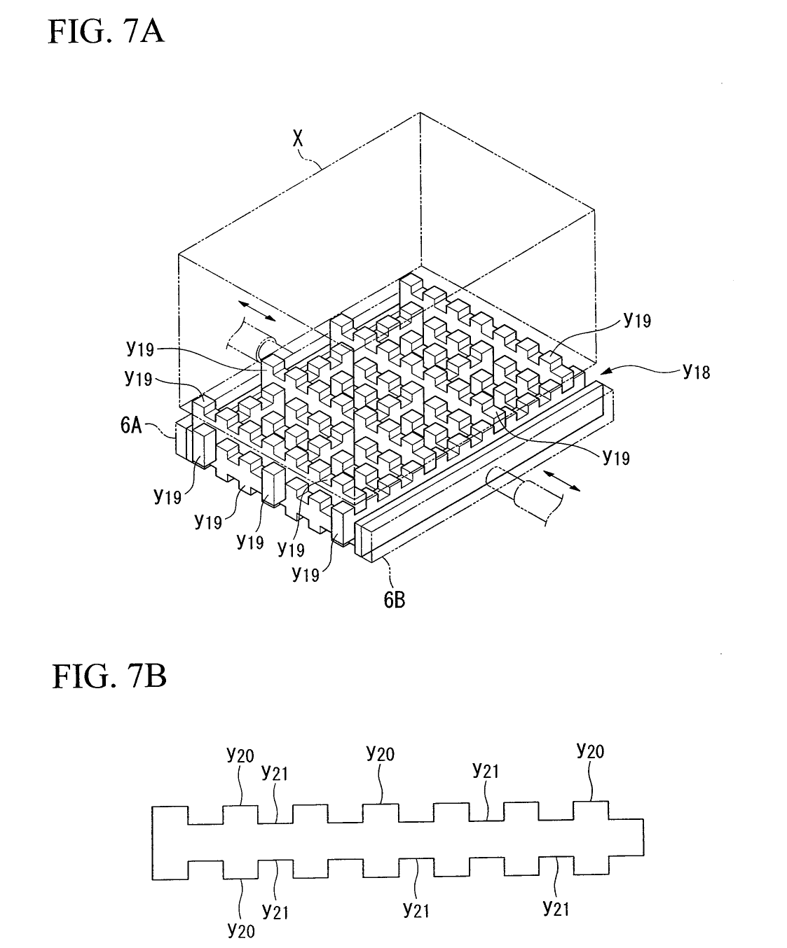

The connecting plates y18 in the fourth embodiment, as shown in FIG. 7A, are formed by connecting a plurality of bar-shaped element members y19 of a predetermined shape that are formed from the base material y5. That is, each bar-shaped element member y19 is a square bar in which convex portions y20 and concave portions y21 are plurally provided as shown in FIG. 7B, with the bars being mutually connected by fitting together the convex portions y20 and the concave portions y21.

Resistance heating occurs in these connecting plates y18 due to contact resistance at the connecting portions of each bar-shaped element member y19. Accordingly, a function similar to the connecting plates y3, y11, y15, y16, and y17 of the above-described first to third embodiments is obtained.

Here, since the connecting plates y18 in the fourth embodiment utilize contact resistance of the connecting portions, the heating value is influenced by the number of connecting portions and the magnitude of the contact resistance thereof. As the number of connecting portions rises, or the contact resistance increases, the overall heating value of the connecting plates y18 increases. Accordingly, it is important to devise a connection method and shape of the bar-shaped element members y19 so that the number of connecting portions increase.

Note that in FIG. 7A, the connecting plate y18 is constituted by stacking the bar-shaped element members y19 up three levels, but it is also acceptable to connect the bar-shaped element members y19 on one level in a planar state such as a jigsaw puzzle.

Also, instead of forming the bar-shaped element members y19 from the base material y5, it is acceptable to form them from the same material as the connecting plates y3, y11, y15, y16, and y17 of the above-described first to third embodiments. In the case of forming the bar-shaped element members y19 in this manner, since the bar-shaped element members y19 themselves undergo resistance heating in addition to resistance heating by the contact resistance of the connecting portions, it is possible to increase the heating value.

1. A heat treatment holder that, in the case of performing heat treatment on an object to be treated, holds the object to be treated and heats the object to be treated by resistance heating elements undergoing resistance heating by carrying electric current from an external source, wherein:
the resistance heating elements are formed by a resistance heating material having a specific resistance higher than a base material of the resistance heating elements being mixed in the base material.

2. The heat treatment holder in accordance with claim 1, wherein the resistance heating elements are formed by the resistance heating material being mixed with the entire base material of the resistance heating elements.

3. The heat treatment holder in accordance with claim 2, wherein the resistance heating elements are formed by the entire base material of the resistance heating elements being alloyed with the resistance heating material.

4. The heat treatment holder in accordance with claim 1, wherein the resistance heating material consists of any one or a plurality of Manganin, non-nickel Manganin, Advance, Cu—Mn—Ge alloy, NBW108, Ni—Cr—Fe alloy, silicon carbide, Nichrome, and graphite.

5. The heat treatment holder in accordance with claim 2, wherein the resistance heating material consists of any one or a plurality of Manganin, non-nickel Manganin, Advance, Cu—Mn—Ge alloy, NBW108, Ni—Cr—Fe alloy, silicon carbide, Nichrome, and graphite.

6. The heat treatment holder in accordance with claim 3, wherein the resistance heating material consists of any one or a plurality of Manganin, non-nickel Manganin, Advance, Cu—Mn—Ge alloy, NBW108, Ni—Cr—Fe alloy, silicon carbide, Nichrome, and graphite.

7. The heat treatment holder in accordance with claim 1, wherein the resistance heating elements are formed by the resistance heating material being mixed at the surface vicinity of the base material of the resistance heating elements.

8. The heat treatment holder in accordance with claim 7, wherein the resistance heating material is carbon (C) that is mixed at the surface vicinity of the base material of the resistance heating elements by performing a carburizing treatment on the base material.

9. A heat treatment holder that, in the case of performing heat treatment on an object to be treated, holds the object to be treated and heats the object to be treated by resistance heating elements undergoing resistance heating by carrying electric current from an external source, wherein:
the resistance heating elements are formed by a resistance heating material having a specific resistance higher than a base material of the resistance heating elements being formed as a coating on the surface of the base material.

10. A heat treatment holder that, in the case of performing heat treatment on an object to be treated, holds the object to be treated and heats the object to be treated by resistance heating elements undergoing resistance heating by carrying electric current from an external source, wherein:
the resistance heating elements are formed by connecting a plurality of element members of a predetermined shape.

11. A heat treatment apparatus, comprising:
a heating container that contains an object to be treated that is held by the heat treatment holder in accordance with claim 1;
an electricity-conducting means for conducting heating electrical current to the heat treatment holder; and
a heating means that heats the object to be treated using heaters that are arranged around the object to be treated.

12. A heat treatment apparatus, comprising:
a heating container that contains an object to be treated that is held by the heat treatment holder in accordance with claim 2;
an electricity-conducting means for conducting heating electrical current to the heat treatment holder; and
a heating means that heats the object to be treated using heaters that are arranged around the object to be treated.

13. A heat treatment apparatus, comprising:
a heating container that contains an object to be treated that is held by the heat treatment holder in accordance with claim 3;
an electricity-conducting means for conducting heating electrical current to the heat treatment holder; and
a heating means that heats the object to be treated using heaters that are arranged around the object to be treated.

14. A heat treatment apparatus, comprising:
a heating container that contains an object to be treated that is held by the heat treatment holder in accordance with claim 4;
an electricity-conducting means for conducting heating electrical current to the heat treatment holder; and
a heating means that heats the object to be treated using heaters that are arranged around the object to be treated.

15. A heat treatment apparatus, comprising:
a heating container that contains an object to be treated that is held by the heat treatment holder in accordance with claim 5;
an electricity-conducting means for conducting heating electrical current to the heat treatment holder; and
a heating means that heats the object to be treated using heaters that are arranged around the object to be treated.

16. A heat treatment apparatus, comprising:
a heating container that contains an object to be treated that is held by the heat treatment holder in accordance with claim 6;
an electricity-conducting means for conducting heating electrical current to the heat treatment holder; and
a heating means that heats the object to be treated using heaters that are arranged around the object to be treated.

17. A heat treatment apparatus, comprising:
a heating container that contains an object to be treated that is held by the heat treatment holder in accordance with claim 7;
an electricity-conducting means for conducting heating electrical current to the heat treatment holder; and
a heating means that heats the object to be treated using heaters that are arranged around the object to be treated.

18. A heat treatment apparatus, comprising:
a heating container that contains an object to be treated that is held by the heat treatment holder in accordance with claim 8;
an electricity-conducting means for conducting heating electrical current to the heat treatment holder; and
a heating means that heats the object to be treated using heaters that are arranged around the object to be treated.

19. A heat treatment apparatus, comprising:
a heating container that contains an object to be treated that is held by the heat treatment holder in accordance with claim 9;
an electricity-conducting means for conducting heating electrical current to the heat treatment holder; and
a heating means that heats the object to be treated using heaters that are arranged around the object to be treated.

20. A heat treatment apparatus, comprising:
a heating container that contains an object to be treated that is held by the heat treatment holder in accordance with claim 10;
an electricity-conducting means for conducting heating electrical current to the heat treatment holder; and
a heating means that heats the object to be treated using heaters that are arranged around the object to be treated.

21. A heat treatment method that consists of holding an object to be treated in a heat treatment apparatus using a heat treatment holder and heating the object to be treated by conducting electrical current to the heat treatment holder and heaters that are arranged around the object to be treated;
characterized by using as the heat treatment holder one that is provided with resistance heating elements in which a resistance heating material having a specific resistance higher than a base material of the resistance heating elements is mixed in the base material.

22. The heat treatment method in accordance with claim 21, wherein the resistance heating elements are formed by the resistance heating material being mixed with the entire base material of the resistance heating elements.

23. The heat treatment method in accordance with claim 22, wherein the resistance heating elements are formed by the entire base material of the resistance heating elements being alloyed with the resistance heating material.

24. The heat treatment method in accordance with claim 21, wherein the resistance heating material consists of any one or a plurality of Manganin, non-nickel Manganin, Advance, Cu—Mn—Ge alloy, NBW108, Ni—Cr—Fe alloy, silicon carbide, Nichrome, and graphite.

25. The heat treatment method in accordance with claim 22, wherein the resistance heating material consists of any one or a plurality of Manganin, non-nickel Manganin, Advance, Cu—Mn—Ge alloy, NBW108, Ni—Cr—Fe alloy, silicon carbide, Nichrome, and graphite.

26. The heat treatment method in accordance with claim 23, wherein the resistance heating material consists of any one or a plurality of Manganin, non-nickel Manganin, Advance, Cu—Mn—Ge alloy, NBW108, Ni—Cr—Fe alloy, silicon carbide, Nichrome, and graphite.

27. The heat treatment method in accordance with claim 21, wherein the heat treatment holder is formed by the resistance heating material being mixed at the surface vicinity of the base material of the heat treatment elements.

28. The heat treatment method in accordance with claim 27, wherein the resistance heating material is carbon (C) that is mixed at the surface vicinity of the base material of the heat treatment elements by performing a carburizing treatment on the base material.

29. A heat treatment method that consists of holding an object to be treated in a heat treatment apparatus using a heat treatment holder and heating the object to be treated by conducting electrical current to the heat treatment holder and heaters that are arranged around the object to be treated;
further comprising using as the heat treatment holder one that is provided with resistance heating elements in which a resistance heating material having a specific resistance higher than a base material of the heat treatment elements is formed as a coating on the surface of the base material.

30. A heat treatment method that consists of holding an object to be treated in a heat treatment apparatus using a heat treatment holder and heating the object to be treated by conducting electrical current to the heat treatment holder and heaters that are arranged around the object to be treated;
further comprising using as the heat treatment holder one that is provided with resistance heating elements that are formed by connecting a plurality of element members of a predetermined shape.
